(19) United States
(12) Patent Application Publication
(10) Pub. No.: US 2006/0289351 A1
(43) Pub. Date: Dec. 28, 2006

(54) Nanostructures synthesized using anodic aluminum oxide

(75) Inventors: Zhili Xiao, Naperville, IL (US); Yurong Han, Lemont, IL (US); Hsien-Hau Wang, Downers Grove, IL (US); Gerold A. Willing, Louisville, KY (US); Ulrich Welp, Lisle, IL (US); Wai-Kwong Kwok, Evanston, IL (US)

Correspondence Address: FOLEY & LARDNER LLP, 150 EAST GILMAN STREET, P.O. BOX 1497, MADISON, WI, 53701-1497, US

(73) Assignee: The University of Chicago

(21) Appl. No.: 11/167,067

(22) Filed: Jun. 24, 2005

Related U.S. Application Data
(60) Provisional application No. 60/585,278, filed on Jul. 2, 2004.

(51) Int. Cl. B01D 71/02

(52) U.S. Cl. 210/500.25; 204/431; 427/245; 428/457; 427/256

(57) ABSTRACT

This invention provides ways to fabricate nanotubes and nanobead arrays by utilizing nanopores in anodic aluminum oxide (AAO) membranes. Nanotubes of bismuth and other low melting point metals with controlled diameters and lengths can be fabricated by sintering AAO coated with appropriate metals at temperatures above their melting points. Carbon nanotubes may also be readily formed by carbonizing a polymer on the interior walls of the nanopores in AAO membranes. Palladium nanobead arrays which can be used as ultrafast hydrogen sensors are fabricated by coating the flat surface of AAO membranes with controlled pore-wall ratios.

### RELATED APPLICATIONS

This application claims priority to U.S. Provisional Application No. 60/585,278, filed Jul. 2, 2004, the entire contents of which is incorporated by reference herein and for all purposes.

### STATEMENT REGARDING FEDERALLY SPONSORED RESEARCH

The United States Government has rights in this invention pursuant to Contract No. W-31-109-ENG-38 between the United States Department of Energy and the University of Chicago representing Argonne National Laboratory.

### FIELD OF THE INVENTION

The present invention relates to novel methods of fabricating nanostructures. In particular the present invention relates to the use of anodic aluminum oxide membranes in the synthesis of nanostructures such as nanotubes and nanobead arrays.

### BACKGROUND OF THE INVENTION

Nanostructures including nanotubes, nanowires, nanoscale dots, antidots and beads are promising subjects for research in studying novel phenomena in confined geometries and have potential applications in many devices. One approach to fabricating nanostructures is by ‘template synthesis’ using the nanopores in porous membranes as templates. There are a few commercially available membranes containing arrays of nanopores, e.g. nuclear track-etched mica and porous polycarbonates. Due to the totally disordered distribution of the pores and large variability of the pore size, however, they are not suitable in applications such as synthesis of nanostructures with uniform size.

Nanoscale dot and bead arrays are of interest in both fundamental research and applications, e.g. as a new generation of ultrahigh density magnetic storage media. A common method of preparing such dot and bead arrays is to pattern magnetic films using electron-beam lithography or focused ion beam milling. Dots and beads with typical submicron sizes have been demonstrated using these advanced techniques. However additional methods allowing for even finer control at the nanometer scale are desirable.

Carbon nanotubes (CNTs) have generated great interest for application in a broad range of potential nanodevices due to their unique structural and electronic properties. Hence, extensive efforts have been made to control the growth and properties of CNT since their discovery in 1991. Large quantities of carbon nanotubes can be produced by arc discharge, laser ablation, or chemical vapor deposition methods. However, the application of CNTs prepared using the aforementioned methods has been hampered because of the limited uniformity of the nanotubes and difficulties with the alignment.

In contrast, template-confined growth of CNTs permits the production of large areas of highly ordered, isolated long CNTs with monodispersed tube diameter and length. In particular, the diameter, length, and packing density of CNTs can be well controlled when the nanotube arrays are fabricated in porous anodic aluminum oxide (AAO) templates. Typically, either carbonization of polymers or pyrolysis of gaseous hydrocarbons has been used to produce CNTs in AAO templates. However, these procedures are not without drawbacks.

For example, graphitic nanotubes have been synthesized by carbonization of polyacrylonitrile or poly(furfuryl alcohol) within the pores of an AAO membrane at 600 and 900° C., respectively. The polymers were introduced into the pores of AAO template by first infiltrating monomers and initiators into the template and carrying out the polymerization afterwards. The whole process including in-situ polymerization followed by calcinations is very tedious and time consuming.

Likewise, pyrolysis procedures also suffer from several disadvantages. Pyrolysis of gaseous hydrocarbons such as C₂H₂, C₂H₄, C₃H₆ can be achieved with or without catalyst, but both processes require specialized reaction chambers, various gas supplies, and pyrolysis temperatures higher than 650° C. More convenient and straightforward methods for the synthesis of CNTs are needed which proceed at lower temperatures and that do not require expensive, specialized equipment.

### SUMMARY OF THE INVENTION

In one aspect, the present invention provides methods of making nanostructures such as nanotubes, nanowires or fibers, and nanodots. The methods include depositing a top layer of a metal on a flat surface of an anodic aluminum oxide (AAO) membrane comprising a periodic array of pores of uniform size. The metal is sintered to wet the pore surfaces with the metal to provide a plurality of nanostructures. In particular, the present methods include wetting a pore surface of an AAO membrane with a metal to provide a metal nanotube, wherein the AAO membrane comprises a periodic array of pores of uniform size. Optionally, the AAO membrane can be removed to release the metal nanostructures.

The top layer of metal can be a single metal or an alloy. Suitable metals for use in the methods include bismuth, lead, aluminum, tin, zinc, indium, antimony and other low melting point metals (e.g., metals melting at or below about 550° C.), alloys or combinations thereof. The top layer of metal can range from about 100 nm to about 1, 2, 3, 4, or even 5 μm thick. The top layer of metal can be deposited by any suitable method known to those of skill in the art, including sputtering, evaporation and electrodeposition.

The methods of making nanostructures can further include depositing a layer of a catalytic metal onto the anodic aluminum oxide surface prior to depositing the top layer of metal thereon, wherein each layer is a different metal. In some such embodiments the catalytic metal can be gold, for example. By contrast the top layer can be, e.g., bismuth. The thickness of the catalytic layer can range from about 10 nm to about 300 nm.

The use of the AAO membrane offers unique advantages over other templates for the fabrication of nanostructures. AAO membranes are readily fabricated according to methods known in the art. Moreover, the pore size and spacing of the pores can be controlled during the synthesis of the AAO membrane. For fabrication of nanotubes, the pore size of the anodic aluminum oxide membrane can range from about 10 or 20 nm to about 100, 200, or even 400 nm in diameter. Furthermore, because of the high heat resistance of the AAO membrane, relatively high temperatures may be used for sintering the metal layer deposited thereon. For example, when the metal layer comprises bismuth, the sintering step may be carried out at 450-600° C. The AAO membrane is typically removed from the nanotubes by exposure of the membrane to a solution of alkali such as sodium hydroxide, potassium hydroxide, and the like.

In another aspect of the invention, there are provided methods of making a nanobead array comprising depositing a layer of Pd nanobeads on a surface of an anodic aluminum oxide membrane comprising a periodic array of pores of uniform size. Typically, the layer of Pd nanobeads is about 5 nm to about 200 nm thick. In the nanobead arrays, the Pd nanobeads are distributed, typically in a uniform fashion, on the surface of an anodic aluminum oxide membrane comprising a periodic array of pores of uniform size. The Pd nanobeads may be doped with one or more other metals such as nickel, cobalt and silver. For fabrication of nanobead arrays, the pore size of the anodic aluminum oxide membrane can range from 4 nm to 400 nm in diameter, and typically ranges from 10 to 200 nm.

In yet a further aspect of the invention, there are provided ultrafast hydrogen gas sensors and methods detecting hydrogen using such sensors. The sensors include an array of Pd nanobeads as described herein. The methods include exposing a Pd nanobead array as described herein to a gas comprising hydrogen; and detecting a change in the electrical conductivity of the Pd nanobead array.

In still another aspect of the invention, there are provided methods for making nanostructures comprising carbon, including nanotubes and nanofibers. Such methods include wetting a pore surface of an AAO membrane with a polymer from a polymer melt or a polymer solution to provide a nanostructure. The AAO membrane used comprises a periodic array of pores of uniform size. In contrast to prior art methods, the present method is operationally simple. In some embodiments the polymer is melted onto the flat surface of the AAO membrane where it spreads out and wets the pore surfaces. In other embodiments, a polymer solution is applied to the flat surface of the AAO membrane where it spreads out and wets the pore surfaces. In contrast to prior art methods, the polymer of the polymer solution is polymerized outside of the pores rather than inside the pores. Typically, the polymer of the polymer solution is simply mixed with an appropriate solvent, such as methylene chloride, chloroform, or tetrahydrofuran, to form a solution of the polymer. Once the polymer has wet the pore surfaces, it can be carbonized, typically by heating under an inert atmosphere such as argon or nitrogen. The AAO membrane can be removed with, e.g., a solution of alkali, to release the carbon nanostructures.

Any polymer which is a carbonizing polymer, i.e., a polymer which does not fully disintegrate and evaporate during carbonization can be used in the practice of the invention. For example, the polymer can be epoxy, bisphenol A propoxylate diglycidyl ether, polyethyleneglycol (PEG), polyisoprene (PI), polyacrylic acid (PAA), polyacrylonitrile (PAN), polymethyl methacrylate (PMMA), polystyrene-block-polybutadiene (PS-PBD), or polystyrene-co-polymethyl methacrylate (PS-PMMA).

Advantageously, the present invention provides for simple methods for preparing carbon nanotubes having a guest nanostructure present within the nanotubes. The methods include simply mixing a guest nanostructures having a size less than the diameter of the pores in the anodic aluminum oxide membrane with the polymer prior to wetting the pore surface with the polymer. The guest nanostructure can be, e.g., a nanoparticle or a nanofiber such as CoPt or Au nanoparticles.

### BRIEF DESCRIPTION OF THE DRAWINGS

FIG. 1 Scanning electron microscopy (SEM) image of a Bi nanotube array synthesized through a high temperature sintering method disclosed herein. The outer diameters of the nanotubes are controlled by the AAO membrane pore diameters.

FIGS. 2A and 2B Atomic force microscopy (AFM) images of 2-dimensional palladium nanobead arrays on anodic aluminum oxide substrates. The palladium thickness for the images in left (2A) and right (2B) panels is 25 nm and 50 nm, respectively.

FIG. 3 Carbon nanotubes of any shapes can be made. a. Carbon nanotubes prepared from epoxy (d=50 nm), b. Carbon nanotubes made from commercial AAO template showing branched openings that reflect the nature of the template, c. Carbon nanotubes with 20 nm diameter, d. Aligned carbon tubes released from the template, e. Carbon nanotubes prepared from PS-PBD, f. Carbon rods prepared from PS-PMMA.

FIG. 4 a. Raman spectra of carbon nanotubes, b. Transmission electron microscopy (TEM) image of CNT bundle, c. Electron diffraction of a carbon tube, d. CNTs can be made at temperatures as low as 400° C., and start to show semiconductivity if made at temperatures above 600° C. e. and f. Nanoparticles of CoPt (6 nm) incorporated into carbon nanotubes with diameters down to 50 nm.

### DETAILED DESCRIPTION OF THE INVENTION

The present invention provides methods of fabricating nanostructures using anodic aluminum oxide membranes as templates and/or supports for the nanostructures. Thus, nanotubes, arrays of palladium nanobeads, and the like may be readily prepared in a predictable fashion using inventive methods. The template AAO membranes include flat surfaces with large-area periodic arrays of uniformly sized pores. The flat surfaces of the AAO membranes include the top and bottom surfaces onto which the pores open or at which the pores end (i.e. blind pores). By “periodic array of pores” it is meant that the pores are positioned relative to each other in a substantially non-random order including, but not limited to, a repeating pattern. The pores of the AAO membranes are of uniform size and thus have diameters that vary by 10% or less or even 5% or less of the average diameter of pores in a given array. In comparison, the variability of pores in other porous membranes such as polycarbonate can be more than 100%.

AAO membranes useful in the invention can be prepared by well known electro-chemical anodization procedures. For example, aluminum foil with a thickness between 0.25 mm and 1 mm can be converted to aluminum oxide by placing the foil in an acid solution under a positive electric field. (See Masuda and Fukuda, Science (1995), 268, 1446-68.) Suitable acids include phosphoric, chromic, oxalic, sulfuric, and the like. The self-organized pore diameters and pore-pore distances can be controlled by changing the anodization voltage and the acid concentration. AAO membranes can be prepared with pore diameters ranging from 10 nm to 400 nm. Pore spacing, measured from the centers of adjacent pores can range from 25 nm to 800 nm. The foil is oxidized to about half its thickness forming blind pores. The thickness of the AAO membranes, which limits the maximum length of the nanowires and nanotubes that can be grown in the pores can be adjusted from about 100 nm to about 1 mm by controlling the anodization time. If required, the aluminum metal foil is removed from the aluminum oxide using, e.g., a copper chloride (CuCl₂) solution.

By way of illustration only, an AAO membrane with pore diameters of about 40 nm and pore spacings of about 100 nm can be prepared as follows. Aluminum foil (0.25 mm thick) is anodized in 0.3 M oxalic acid at 40V and 3° C. for 24 hours. The layer of AAO can be removed by treatment with a mixture of chromic (1.8 weight percent (wt %)) and phosphoric (6 wt %) acids at 60° C. for 12 hours. A second anodization is conducted as before. Optionally, the unanodized aluminum is removed with saturated HgCl₂ or 0.1 M CuCl₂ with the anodized surface protected with a polymer such as nail polish. The bottom of the channels may then be opened by treatment with 5 wt % phosphoric acid for 1 to 2 hours. The protecting layer of polymer can be removed with an organic solvent such as acetone. Hence, both top and bottom surfaces (i.e., the flat surfaces) as well as the cylindrical pores of the AAO membranes can be utilized to synthesize novel nanostructures and nanostructure supports.

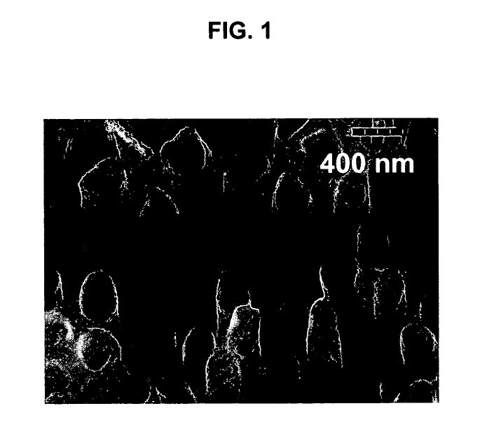

Due to its stability at high temperature, an AAO membrane is an ideal template for synthesizing nanotubes through either wetting or vapor deposition mechanisms. For example, AAO membranes can be used as templates to fabricate bismuth nanotubes that up to now have only been obtained by thermal decomposition, a technique which does not allow for control of their lengths and diameters. First, an AAO membrane with ordered nanopores is coated with a Bi layer on one surface. Sintering the bismuth coated AAO membrane at temperatures of 450-600° C. induces bismuth to wet the interior walls of the AAO nanopores to form bismuth nanotubes. Various sizes of bismuth nanotubes can be fabricated by adjusting the pore diameters of the nanopores in AAO membrane. FIG. 1 shows an SEM image of free-standing bismuth nanotubes after completely etching the AAO support matrix with a sodium hydroxide solution.

The periodic array of nanopores in AAO membranes also enables the fabrication of highly ordered nanobead arrays by coating the surfaces of the AAO membranes with various materials of interest. For example, highly ordered nanobead arrays can be formed by coating a flat surface(s) of the AAO membranes with palladium. The palladium may include dopants such as Ni, Co, Ag and the like, and can be deposited on the AAO membranes using sputtering or evaporation techniques well known in the art. (For example, a Polaron E6700 evaporator may be used with a base pressure in the vacuum chamber of about 10-6 Torr and an evaporating rate of 0.1 Å/s; see Xu, T., et al., Appl. Phys. Lett. 86, 203104 (2005).) By highly ordered, it is meant that the nanobead arrays are substantially non-random in the distribution of the nanobeads. Thus, one skilled in the art would understand that the nanobeads in arrays of the invention are uniformly distributed on a flat surface of the AAO membrane but that such a distribution is not invariant. A fraction of the beads, e.g. up to 1-10, 15, or even 20% of the beads may be randomly distributed in the array.

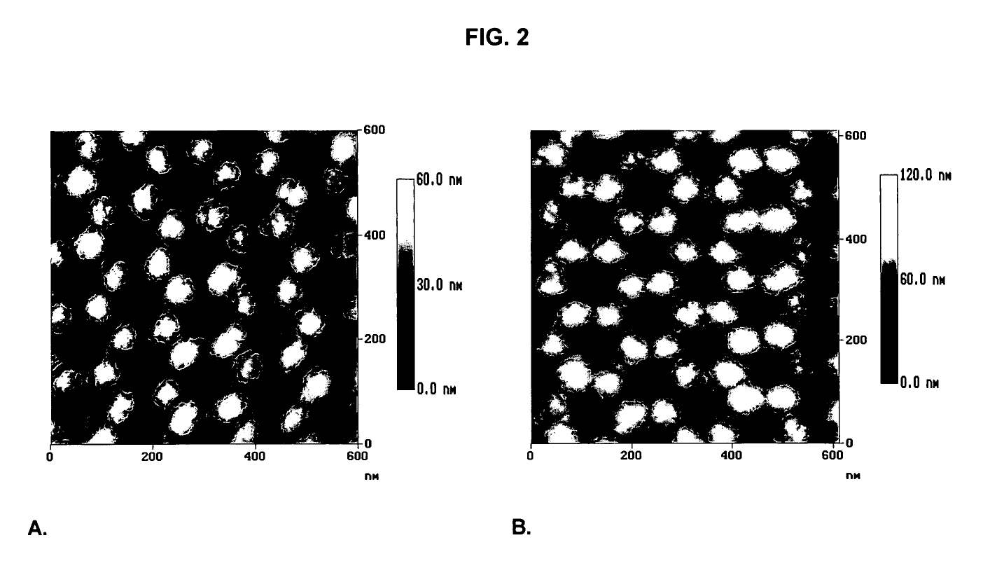

Atomic force microscopy images in FIG. 2 show the morphologies of palladium nanobead arrays synthesized by coating palladium with a thickness of about 25 nm and 50 nm onto AAO membranes with a pore to wall ratio of about 5:1. The palladium clearly forms highly ordered nanobead arrays on the AAO surface. The contact areas of the nanobeads can be controlled by adjusting the thickness of the palladium coating. For example, as shown in the left panel of FIG. 2, noticeable gaps between nanobeads can be clearly seen when the palladium is only 25 nm thick while all nanobeads are connected when the palladium thickness is 50 nm.

Such arrays can be used as the key components in ultrafast hydrogen sensors. See, e.g., Favier et al., Science, 293, 2227-31 (2001). To construct the hydrogen sensors, an AAO membrane having a Pd nanobead array according to the invention is simply attached by leads to any suitable device that can measure the voltage when current is passed through the membrane/nanobead array. Using this sensor, hydrogen concentration can be measured as a function of the change in conductivity of the Pd nanobead arrays. While not wishing to be bound by theory, it is believed that the change in conductivity results from the dilation of the nanobeads upon exposure to hydrogen. As the Pd absorbs hydrogen, the nanobeads dilate, causing an increase in the contact areas between the beads. The increased contact areas lead to a decrease in the resistance of the nanobead array. This is in marked contrast to previous hydrogen sensors utilizing bulk Pd in which resistance increases in the presence of hydrogen due to the formation of palladium hydride.

The present method of preparing nanobead arrays is superior to previous methods. For example, in comparison to the nanobead chains fabricated utilizing an electrodeposition technique and step edges on graphite surfaces, the present thin film approach using AAO membranes is more controllable and allows for easily doping the nanobeads by either using an alloy target or by multiple target co-sputtering. The doped palladium nanobead arrays can enhance the selectivity and sensitivity in hydrogen sensing.

In another aspect, methods of the invention include a simple, fast, one step approach for preparing carbon nanostructures, particularly a well aligned carbon nanotube array. Solid polymer or drops of polymer solution are placed on a flat surface (e.g., the top surface onto which the pores open) of an AAO template, and the template with polymer is put into a tube furnace. The temperature is slowly increased at a rate of about 2° C./min to the desired temperature and held there for sufficient time (e.g., 3 hours) under an Ar flow to fully carbonize the polymer tubes. The polymer initially melts and flows into the nanopores of the AAO template to form polymer nanotubes. Starting at very low temperature, e.g. about 400° C., the polymers are carbonized and graphitic nanotubes are generated. Typical carbonization temperature range from about 500 to about 600° C. There is no additional catalyst involved, no polymerization, and no special equipment is required.

By way of illustration only, CNTs were prepared using three types of porous AAO templates. One was a commercially available membrane with 60 μm thickness and 230 nm pore diameter (Whatman Ltd. Anodisc 13). The other two were prepared by anodic oxidation of high purity aluminum plates through a two-step anodization process described above. The membranes were 60 μm thick and the pore diameters were 50 and 20 nm, respectively. The resultant CNTs were freed from the templates by soaking in 1 M aq. NaOH, rinsed twice with distilled water and EtOH, and then dispersed into EtOH by ultrasonic agitation. One drop of the suspension was added to a TEM grid for SEM, TEM, and micro-Raman characterization.

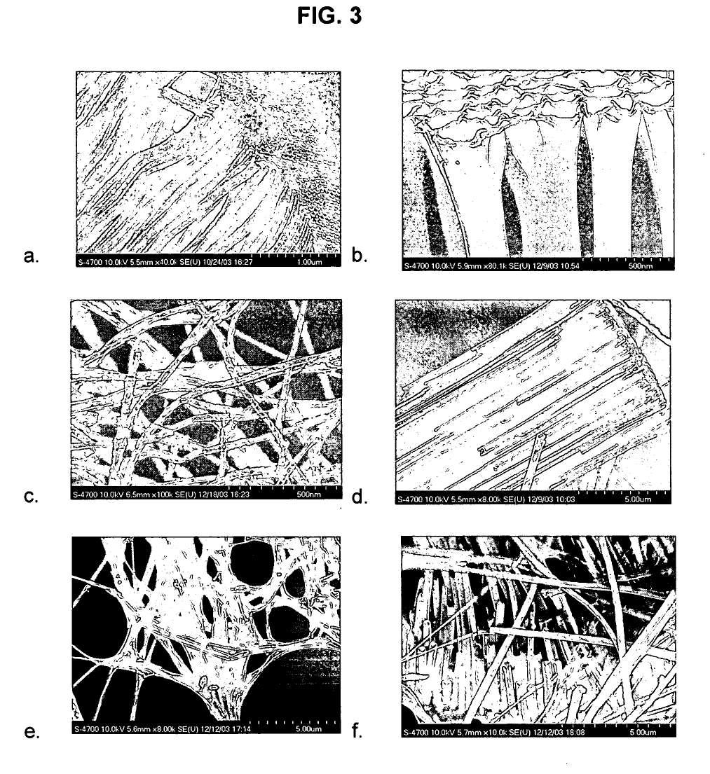

When a polymer melt or solution is placed on a substrate with high surface energy, it will spread to form a thin film. Similar wetting phenomena occur if porous templates are brought into contact with polymer melts or solutions. The nanotube structure can be preserved if the wetting process is quenched at the initial stage since the wall wetting and complete filling of the pores take place at different time scales. In the present methods, the wetting of the template walls happens on a time scale of a few minutes when any liquid form of epoxy (e.g. silver epoxy or 5-minute epoxy) was used as starting materials. The fully crosslinked epoxy nanotubes are released from the AAO template by dissolving the alumina template in a 1 M NaOH solution (FIG. 3a). The epoxy tubes are of uniform diameter and length, with wall thickness of several tens of nanometers. It was found that the topography of the epoxy tubes match the shape of their host pore channels so well that they can be used to copy the internal pore structure faithfully. Further carbonization does not change the morphology of the nanotubes prepared from epoxy (FIG. 3b). Thus, the use of electron microscopy is a reliable approach to study the pore structure since the conductive nature of the carbonized nanotubes means that no additional carbon or metal coating are needed for imaging. AAO templates with pore diameters as small as 20 nm were also used successfully for CNTs growth (FIG. 3c). The AAO pore diameters can be increased or decreased by wet chemical etching and atomic layer deposition methods, respectively. CNTs grown in the AAO template are very flexible and can be bent 180 degree without being broken. The CNTs produced are of uniform length and have open-ends that facilitate their use in sensing applications.

Methods of the invention for the preparation of CNTs provide several advantages. All the CNTs are of equal height and there is no problem with overgrowth as commonly occurs using CVD growth techniques. The nanotubes are well ordered, parallel to each other and transverse (e.g., perpendicular) to the template to form a periodic hexagonal close-packed array without extra processing steps (FIG. 3d). The tube density, estimate from the pore density, can be as high as 4.4×10¹⁰ pores/cm². The tube diameter distribution throughout the array is narrow, typically ±10% or less of the average diameter. This size distribution is much narrower than heretofore reported using other methods of nanotube array synthesis. Thus, in another aspect the invention provides arrays of carbon nanotubes prepared using the methods described herein, in which substantially all of the diameters of the nanotubes are within 10% of the average diameter of nanotubes in the array.

Inventive methods are widely applicable to all carbonizing polymers—i.e., polymers that do not fully disintegrate and vaporize during carbonization. Thus, epoxy and other polymers disclosed herein are carbonizing polymers. Only a few polymers are not carbonizing polymers such as polystyrene and polybisphenol A carbonate; these polymers disintegrate and escape the template cleanly as gaseous molecules.

It has been discovered that different polymer precursors resulted in CNTs with different structures. For example, polystyrene-block-polybutadiene (PS-PBD) generated CNTs with very thin walls so they appear flat (FIG. 3e) and polystyrene-co-polymethyl mathacrylate (PS-PMMA) resulted in solid carbon fibers instead of nanotubes (FIG. 3f).

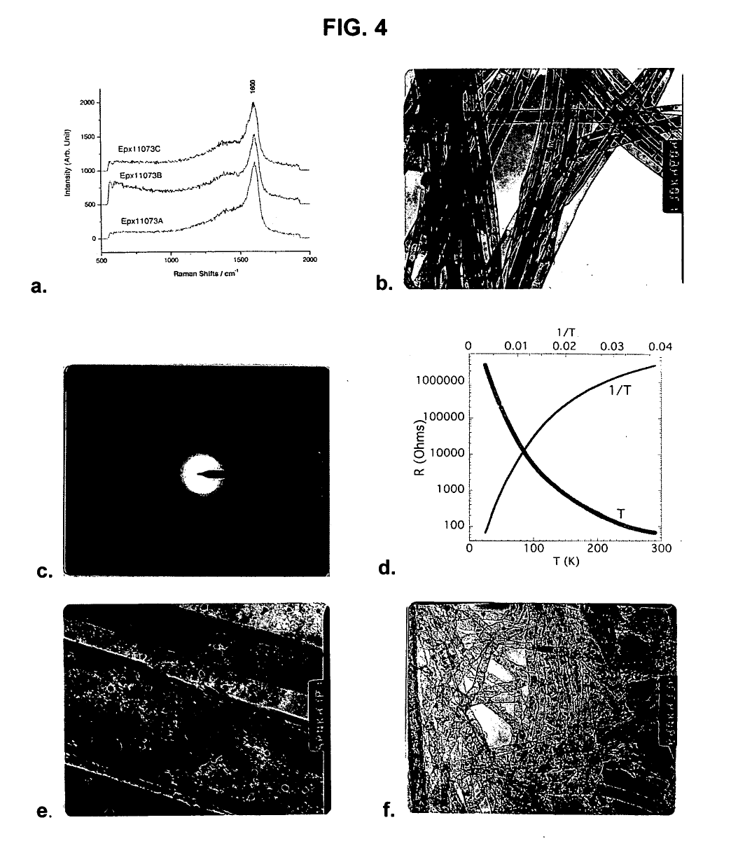

Raman spectra of these carbon nanotubes were recorded on a microscope spectrometer using an Ar laser excitation (514.5 nm, 5 mW) and a 100× objective (laser spot ˜1 um). The resolution is 1 cm⁻¹ and the spectra were the average of 10 accumulations of 50 s each. A typical Raman spectrum is presented in FIG. 4a where two broad and relatively intense peaks at 1345 and 1589 cm⁻¹ can be observed. The sample is relatively homogeneous throughout the whole 60 μm length. Spectra recorded at different points of the sample did not differ notably. The relative intensity of the D band at 1353 cm⁻¹ to the G band at 1585 cm⁻¹ is low indicating that the CNTs have a good graphitized structure. The D band is due to disordered small crystalline size sp carbon. For most CNTs fabricated by CVD, the D band is broader and stronger than the G band.

Further sample characterization was carried out using transmission electron microscopy and electron diffraction. FIG. 4b shows a TEM image of a carbon nanotube bundle which resulted from complete removal of the AAO template. The electron diffraction patterns of the nanotube bundle in FIG. 4c show that the carbon fibers are not only crystalline but also somewhat graphitic with an interwall distance (d₀₀₂) of approximately 3.6 A, slightly larger than the interplanar separation in graphite (d₀₀₂=3.35 A). The tube wall thickness was found to lie in the range of 4-5 nm, suggesting the tubes are composed of approximately 12 graphitic shells. The brightest ring corresponds to the 002 reflection of hexagonal graphite. The next continuous ring seen in the diffraction pattern corresponds to the 110 reflection of hexagonal graphite. There is no difference in the intensity in this particular diffracted ring, which suggests that there is no preferred orientation along the a- or b axes. The third diffraction ring, however, which corresponds to the 004 reflection of graphite, is oriented in the same manner as the 002 orientation. The transport measurements made on a 50 nm CNT array embedded in AAO template by a two probe method show the characteristics of a semiconductor (FIG. 4d).

Another advantage of the current process is that it can be easily extended to prepare functionalized nanotubes by simply mixing any type of nanospecies, such as nanoparticles or nanofibers with the polymer prior to use, and then allowing the wetting process bring these nanospecies into the template channels to form various functional nanotubes. For example, CoPt nanoparticles with 6 nm diameter had been successfully incorporated into carbon nanotubes with diameters down to 50 nm by this method (FIG. 4e-f). This is a simple one-step method and is in contrast to the CVD method where it is not possible to simultaneously grow the carbon tubes and introduce metallic nanoparticles. The functioning carbon nanotubes are expected to be useful in various applications in catalysis.

The method of nanotube array synthesis has no inherent area limitation and can be scaled up with the template size. AAO templates can be made as large as needed. Therefore, one can make large panels of well-aligned carbon nanotubes, which may find use as a cold-cathode flat panel display.

One skilled in the art will readily realize that all ranges discussed can and do necessarily describe all subranges therein for all purposes and that all such subranges also form part and parcel of this invention. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

We claim:

1. A method comprising:
depositing a top layer of a metal on a flat surface of an anodic aluminum oxide membrane comprising a periodic array of pores of uniform size; and
sintering the metal to wet the pore surfaces with the metal to provide a plurality of nanostructures.

2. The method of claim 1 wherein the plurality of nanostructure are nanotubes or nanowires.

3. The method of claim 1 wherein the metal is bismuth, lead, aluminum, tin, zinc, indium, antimony, or an alloy thereof.

4. The method of claim 1 wherein the top layer of metal is about 100 nm to about 5 μm thick.

5. The method of claim 1 further comprising depositing a layer of a catalytic metal onto the anodic aluminum oxide surface prior to depositing the top layer of metal thereon, wherein each layer is a different metal.

6. The method of claim 5 wherein the layer of catalytic metal is gold.

7. The method of claim 6 wherein the top layer of metal is bismuth.

8. The method of claim 1 wherein the top layer of metal is deposited by sputtering, evaporation and electrodeposition.

9. The method of claim 1 further comprising removing the anodic aluminum oxide membrane to release the metal nanostructures.

10. The method of claim 1 wherein the anodic aluminum oxide membrane is removed with a solution of alkali.

11. The method of claim 1 wherein the pore size of the anodic aluminum oxide membrane is about 10 nm to about 400 nm in diameter.

12. A method comprising wetting a pore surface of an anodic aluminum oxide membrane with a metal to provide a metal nanotube, wherein the anodic aluminum oxide membrane comprises a periodic array of pores of uniform size.

13. A method of making a nanobead array comprising depositing a layer of Pd on a flat surface of an anodic aluminum oxide membrane comprising a periodic array of pores of uniform size.

14. The method of claim 13 wherein the layer of Pd is about 5 nm to about 200 nm thick.

15. A composition comprising an array of Pd nanobeads prepared by the method of claim 13 and distributed on a flat surface of the anodic aluminum oxide membrane.

16. The nanobead array of claim 15 wherein the Pd nanobeads are uniformly distributed.

17. The array of claim 15 wherein the Pd nanobeads are 10 nm to 200 nm thick.

18. The nanobead array of claim 15 wherein the Pd nanobeads are doped with one or more metals.

19. The nanobead array of claim 15 wherein the pore size of the anodic aluminum oxide membrane is 4 nm to 400 nm in diameter.

20. A hydrogen sensor comprising the Pd nanobead array of claim 15.

21. A method of detecting hydrogen comprising:
exposing a Pd nanobead array of claim 15 to a gas comprising hydrogen; and
detecting an change in the electrical conductivity of the Pd nanobead arrays.

22. A method comprising wetting a pore surface of an anodic aluminum oxide membrane with a polymer from a polymer melt or a polymer solution to provide a nanostructure, wherein the anodic aluminum oxide membrane comprises a periodic array of pores of uniform size, and the polymer of the polymer solution is polymerized outside of the pores.

23. The method of claim 22 further comprising carbonizing the polymer.

24. The method of claim 23 wherein the carbonizing takes place under an inert atmosphere.

25. The method of claim 22 further comprising depositing the polymer on a flat surface of the anodic aluminum oxide membrane.

26. The method of claim 23 further comprising removing the anodic aluminum membrane to release the nanostructures.

27. The method of claim 22 wherein the anodic aluminum oxide membrane is removed with a solution of alkali.

28. The method of claim 22 wherein the nanostructure is a nanotube or nanofiber.

29. The method of claim 22 wherein the polymer is an epoxy, bisphenol A propoxylate diglycidyl ether, polyethyleneglycol, polyisoprene, polyacrylic acid, polyacrylonitrile, polymethyl methacrylate, polystyrene-block-polybutadiene, or polystyrene-block-polymethyl methacrylate.

30. The method of claim 23 wherein the nanostructure is a nanotube and a guest nanostructure having a size less than the diameter of the pores in the anodic aluminum oxide membrane is mixed with the polymer prior to wetting the pore surface with the polymer, to provide a nanotube having a guest nanostructure within the tube.

31. The method of claim 30 wherein the guest nanostructure is a nanoparticle or a nanofiber.

32. The method of claim 31 wherein the nanoparticle is a CoPt or Au nanoparticle.
